(19) United States
(12) Patent Application Publication
(10) Pub. No.: US 2005/0257574 A1
(43) Pub. Date: Nov. 24, 2005

(54) Washing machine with improved decoration panel mounting structure and method of mounting decoration panel on washing maching

(75) Inventor: Jae Cheol Lyu, Changwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/132,235

(22) Filed: May 19, 2005

(30) Foreign Application Priority Data
May 20, 2004 (KR) 35809/2004

(51) Int. Cl. D06F 37/00; B08B 3/12; D06F 33/00

(52) U.S. Cl. 68/3 R; 68/12.01; 29/428; 29/505

(57) ABSTRACT

Provided is a washing machine includes a case, a washing tub disposed in the case to load laundry, a console disposed on a top of the case and provided with a plurality of coupling holes, and a decoration panel disposed on a front surface of the console. The decoration panel is provided with a plurality of coupling ribs inserted into the coupling holes of the console.

### BACKGROUND OF THE INVENTION

1. Field of the Invention

The present invention relates to a washing machine, and more particularly, to a washing machine with an improved decoration panel mounting structure that can mount a decoration panel around a control panel to prevent the washing machine from being burnt by the over-heating of the control panel and to improve the outer appearance of the washing machine. The present invention further relates to a method of mounting the decoration panel on a washing machine.

2. Description of the Related Art

Generally, a washing machine is designed to remove dirt from the laundry using surface activation of detergent dissolved in washing water. Using main power from a driving motor connected to a washing tub in which the laundry is loaded, the washing machine performs a series of processes such as a washing process, a rinsing process, and a spin-drying process.

The washing machine may be classified into a cylinder type, an agitator type and a pulsator type.

The cylinder type washing machine has a drum provided at an inner surface with a plurality of laundry-lifting plates. By the laundry-lifting plates, the laundry loaded in the drum is lifted and fallen when the drum rotates slowly around a horizontal shaft. When the laundry is lifted and fallen, impact is applied to the laundry to wash the laundry.

In addition, the agitator type washing machine is designed to perform the washing operation by rotating a wing-shaped agitator projected upward from a bottom center of the washing tub.

In addition, the pulsator type washing machine is designed to perform the washing operation using water current generated by the rotation of a disk-shaped pulsator.

Since the conventional washing machines are well known in the art, the detailed description thereof will be omitted herein.

Meanwhile, in the conventional washing machine, a decoration panel is mounted around a control panel to prevent outer impact from being applied to the control panel, thereby preventing the control panel from being damaged or broken.

To mount the decoration panel to the control panel, a plurality of fasteners such as screws have to be used, thereby increasing the manufacturing costs of the washing machine, complicating the assembling process, and deteriorating the outer appearance of the washing machine.

### SUMMARY OF THE INVENTION

Accordingly, the present invention is directed to an assembling structure and method of installing a decoration panel on a washing machine that substantially obviates one or more problems due to limitations and disadvantages of the related art.

An object of the present invention is to provide a washing machine with an improved decoration panel mounting structure that can mount a decoration panel on a control panel without using any coupling member by improving a coupling structure between the decoration panel and the control panel.

Another object of the present invention is to provide a method of mounting a decoration panel on a control panel of a washing machine without using any coupling member, thereby reducing the costs and improving the assembling efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a washing machine including: a case; a washing tub disposed in the case to load laundry; a console disposed on a top of the case and provided with a plurality of coupling holes; and a decoration panel disposed on a front surface of the console, the decoration panel being provided with a plurality of coupling ribs inserted into the coupling holes of the console.

In another aspect of the present invention, there is provided a washing machine with a decoration panel mounting structure, including: a console having a rear surface on which a PCB is mounted; a control panel mounted on a front surface of the console; a decoration panel comprising a panel body mounted on the front surface of the console and provided with an insertion hole in which the control panel is fitted, bending ends formed on inner and/or outer rim of the panel body, and a plurality of ribs extending from the bending ends; and a decoration panel mounting unit comprising a groove on the front surface of the console to receive the bending ends, a decoration panel seating portion formed on a portion enclosed by the groove, and an insertion holes formed on the groove to receive the ribs.

In still another aspect of the present invention, there is provided a method of mounting a decoration panel on a washing machine, including: disposing a console on a top surface of a top cover of the washing machine; inserting coupling ribs formed on a lower end of the decoration panel and/or on an inner rim of the decoration panel into coupling holes formed on the console; and bending the coupling ribs inserted through the coupling holes so that the coupling ribs closely contact a rear surface of the console.

According to the present invention, since no separate coupling member is required to mount the decoration panel on the control panel, the manufacturing cost and time can be saved.

In addition, since the decoration panel is formed of metal, even when there is a fire by the over-heating of the control panel, the spreading of the fire to other portions of the washing machine can be prevented.

Furthermore, since the coupling portion is not appeared to an external side, the appearance of the washing machine can be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a washing machine employing an improved decoration panel mounting structure according to an embodiment of the present invention;

FIG. 2 is a rear perspective view of a decoration panel according to an embodiment of the present invention; and

FIG. 3 is a perspective view of a console provided with a decoration panel mounting structure according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

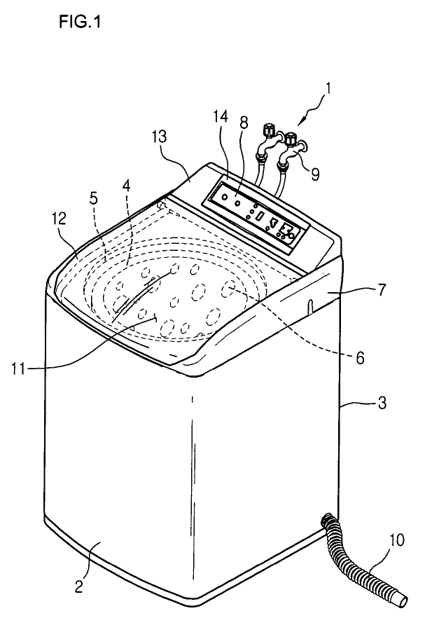

FIG. 1 is a perspective view of a washing machine employing an improved decoration panel mounting structure according to an embodiment of the present invention.

Referring to FIG. 1, a washing machine 1 includes a case 2, a back cover 3 covering a back surface of the case 2, and an outer tub 5 installed in the case 2 to store washing water.

The washing machine 1 further includes an inner tub 4 rotatably installed in the outer tub 5 to store the washing water. The inner tub 4 is provided with a plurality of holes 6 through which the washing water stored in the outer tub 5 can flow into the inner tub 4.

The washing machine 1 further includes a top cover 7 disposed on a top of the case 2 and a drain hose 10 connected to a lower portion of the case to drain the washing water to an external side. The washing machine 1 further include a driving motor (not shown) installed on a bottom of the inner tub 4 to provide rotational force to the inner tub 4.

The case 2 is provided at the top with a laundry loading opening 11 through which the laundry is loaded into the inner tub 4. A lid 12 is pivotally coupled to the top cover 7 to selectively open/close the laundry loading opening 11.

The washing machine 1 includes a control panel 8 formed on the top cover 7 to allow a user to input washing mode, a console 13 on which the control panel 8 is disposed, and a water supply hose 9 connected to a rear surface of the console 13 to supply the washing water into the outer tub 5.

A rubber packing may be provided on the top surface of the top cover 7 to prevent the lid 12 is damaged by absorbing impact generated when the lid 12 contacts the top cover 7.

A rubber packing may be also provided on a bottom of the lid 12 to absorb impact generated when the lid 12 contacts the top cover 7

In order to effectively absorb the impact, the rubber packing may be formed in a band-shape, which is formed on a portion of the top cover 7 that is to contact the lid 12.

The operation of the above-described washing machine will be described hereinafter.

The user lifts the lid 12 to open the laundry loading opening 11 and loads the laundry into the inner tub 13 through the laundry loading opening 11. Then, the user inputs detergent into the inner tub 13.

When the user manipulates the control panel 8 to turn on a washing mode of the washing machine 1, the washing water is supplied into the outer tub 5 through the water supply hose 9. The washing water flows into the inner tub 4 through the holes formed on the inner tub 4.

Then, the inner tub 4 rotates clockwise and counterclockwise by the driving motor, thereby performing the washing process. When the washing process is finished, the contaminated water is drained out of the washing machine 1 through the drain hose 10.

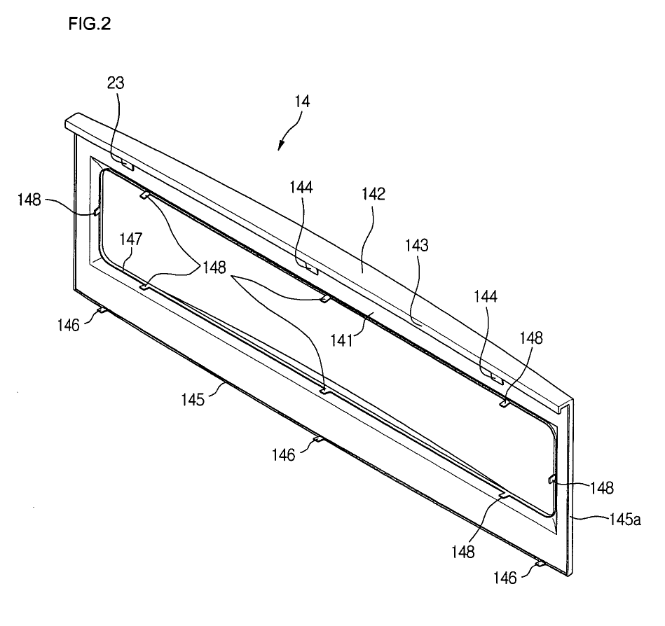

FIG. 2 shows the decoration panel according to an embodiment of the present invention.

Referring to FIG. 2, the decoration panel 14 is disposed on a front surface of the console 13 mounted on a top-rear portion of the washing machine 1.

The decoration panel 14 is formed in a rectangular shape and is provided with a control panel insertion hole 149 in which the control panel 8 is inserted. That is, the decoration panel 14 includes a rectangular panel body 141 provided with a predetermined hole and a panel upper 142 extending rearward from a top of the panel body 141. A rear end of the panel upper 142 is bent downward to define an upper bending end 143. A plurality of upper coupling ribs 144 are formed extending from a lower end of the upper bending end 143. The upper coupling ribs are more than two in number, which are spaced from each other by a predetermined distance.

A lower end of the decoration panel 14 is bent rearward to define a lower bending end 145. Opposite side ends of the decoration panel 14 are bent rearward to define side bending ends 145a. A plurality of lower coupling ribs 144 are formed extending from a rear end of the lower bending end 145. The lower coupling ribs 144 are spaced away from each other by a predetermined distance.

An inner rim of the decoration panel 14 is bent rearward to define an inner bending end 147. A plurality of inner coupling ribs 148 are formed extending from upper, lower and side portions of the inner bending end 147. Here, the decoration panel 14 may be formed of metal having predetermined flexibility so that the coupling ribs 144, 146 and 148 can be easily bent from the bending ends 143, 145, 145a, and 147.

After the above-described decoration panel 14 is mounted on the console 13, the control panel 8 is disposed on the console 13 through the control panel insertion hole 149. Then, the coupling ribs 144, 146 and 148 formed on the decoration panel 14 are inserted in insertion holes formed on the console 13 and bent to closely contact the rear surface of the console 13, thereby securely fixing the decoration panel 14 on the console 13. The coupling process of the decoration panel 14 to the console 13 will be described in more detail later.

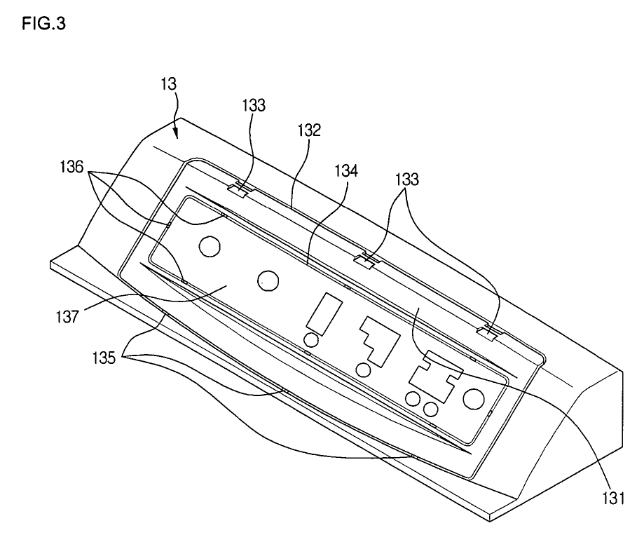

FIG. 3 shows the console provided with a decoration panel mounting structure according to an embodiment of the present invention.

Referring to FIG. 3, the console 13 is disposed on the top-rear portion of the top cover 7. The laundry loading opening 11 is formed in front of the console 13. A PCB having an LED or LCD displaying the operation mode and time is mounted in rear of the console 13. A front portion of the console 13 is inclined downward by a predetermined angle. The control panel 8 is disposed on the inclined surface of the console 13 so that the user can easily identify the washing process displayed on the control panel 8.

Describing in more detail, The console 13 is provided at a front portion with a decoration panel mounting portion 131 on which the decoration panel is mounted. The decoration panel mounting portion 131 is depressed from the surface of the console 13. An outer groove 132 depressed by a predetermined depth is formed along a rim of the decoration panel mounting portion 13. The bending ends 143, 145 and 145a formed on the decoration panel 14 are inserted in the outer groove 132. A rim-shaped inner groove 134 is formed on an inner portion of the decoration panel mounting portion 131. The inner bending end 147 of the decoration panel 14 is inserted in the inner groove 134. That is, by inserting the bending ends of the decoration panel in the outer and inner grooves 132 and 134, the movement of the decoration panel 14 mounted on the console 13 can be prevented. A control panel mounting portion 137 is formed inside the inner groove. That is, the decoration panel mounting portion 131 and the control panel mounting portion 137 are separated by the inner groove 134.

The decoration panel mounting portion 131 is provided on a top surface with a plurality of upper fixing grooves 133 in which the upper coupling ribs 144 extending from the top end of the decoration panel 14 are inserted. A plurality of lower coupling holes 135 are formed on a lower portion of the outer groove 132. The lower coupling ribs 146 extending from the lower end of the decoration panel 14 are inserted.

The inner groove 134 is provided with a plurality of inner coupling holes 136 in which the inner coupling ribs 148 formed on the inner rim of the decoration panel 14.

That is, the coupling ribs 144, 146, 148 formed on the decoration panel 14 are inserted into the corresponding coupling holes 133, 135 and 136 formed on the outer and inner grooves 132 and 134.

In order for the coupling ribs inserted into the coupling holes to be bent, each coupling rib is preferably designed having a length projected enough rearward of the console over the coupling hole. It is further preferable that an end of each coupling rib is rounded so that it can be easily inserted into the corresponding coupling hole.

An assembling process of the control panel 14 on the console 13 will be described hereinafter with reference to FIGS. 2 and 3.

First, the upper coupling ribs 144 of the decoration panel 14 are inserted in the upper fixing grooves 133 of the console 13. Here, in order to allow the upper coupling ribs 144 to be inserted from a rear side of the upper fixing grooves 133 to a front side of the upper fixing grooves 133, the ribs 144 are inserted in a state where a lower side of the decoration panel 14 is higher than an upper side of the decoration panel 14. In addition, in a state where the upper coupling ribs 144 are inserted into the upper fixing grooves 133, the decoration panel 14 is pivoted such that the lower side of the panel 14 is disposed on the console 13. Then, the lower coupling ribs 146 formed on the lower end of the decoration panel and the inner coupling ribs 148 formed on the inner bending end 147 are respectively inserted in the lower and inner coupling holes 135 and 136 of the console 13. Then, the bending ends 143, 145, 145a, 147 of the decoration panel 14 are inserted into the corresponding outer and inner grooves 132 and 134 and the decoration panel 14 is depressed.

Meanwhile, in a state where the decoration panel 14 is disposed on the console 13, the inner and lower ribs 148 and 146 projected rearward of the console 13 are bent to closely contact the rear surface of the console 13.

By the above-described assembling process, the decoration panel 14 can be securely and closely coupled to the front surface of the console 13 without using any separate coupling members.

It will be apparent to those skilled in the art that various modifications and variations can be made in the present invention. Thus, it is intended that the present invention covers the modifications and variations of this invention provided they come within the scope of the appended claims and their equivalents.

1. A washing machine comprising:
a case;
a washing tub disposed in the case to load laundry;
a console disposed on a top of the case and provided with a plurality of coupling holes; and
a decoration panel disposed on a front surface of the console, the decoration panel being provided with a plurality of coupling ribs inserted into the coupling holes of the console.

2. The washing machine according to claim 1, wherein the coupling ribs are formed extending from inner and/or outer rims of the decoration panel.

3. The washing machine according to claim 1, wherein the console is provided with a decoration panel mounting portion, which is depressed to receive the decoration panel.

4. The washing machine according to claim 1, wherein the console is provided with a groove in which the inner and/or outer rim of the decoration panel is inserted.

5. The washing machine according to claim 1, further comprising a control panel wherein washing machine further comprises a control panel disposed on an inner side of the decoration panel.

6. The washing machine according to claim 1, wherein the decoration panel is provided with an insertion hole in which the control panel is fitted.

7. The washing machine according to claim 1, wherein the decoration panel comprises:
a panel body provided with a hole in which a control panel is fitted;
a panel upper extending rearward from an upper end of the panel body; and
bending portions formed by bending lower and side ends of the panel body and by bending an end of the panel upper.

8. The washing machine according to claim 7, wherein the coupling ribs extends from ends of the bending portions.

9. The washing machine according to claim 4, wherein the coupling holes are from on the grooves and spaced away from each other by a predetermined distance.

10. A washing machine with a decoration panel mounting structure, comprising:
a console having a rear surface on which a PCB is mounted;
a control panel mounted on a front surface of the console;
a decoration panel comprising a panel body mounted on the front surface of the console and provided with an insertion hole in which the control panel is fitted, bending ends formed on inner and/or outer rim of the panel body, and a plurality of ribs extending from the bending ends; and
a decoration panel mounting unit comprising a groove on the front surface of the console to receive the bending ends, a decoration panel seating portion formed on a portion enclosed by the groove, and an insertion holes formed on the groove to receive the ribs.

11. The washing machine according to claim 10, wherein the groove comprises:
a first groove in which the bending ends formed on the outer rim of the decoration panel are inserted; and
a second groove in which the bending ends formed on the inner rim of the decoration panel are inserted.

12. The washing machine according to claim 10, wherein the decoration panel mounting portion is provided with at least one insertion hole in which the rib is rotatably inserted.

13. The washing machine according to claim 10, wherein the rib is designed having a length equal to or greater than a thickness of the console.

14. The washing machine according to claim 10, wherein the decoration panel is formed of metal having predetermined flexibility so that the rib can be effectively bent.

15. The washing machine according to claim 10, wherein an end of the rib is rounded.

16. The washing machine according to claim 10, wherein the groove is formed in a rim-shape.

17. A method of mounting a decoration panel on a washing machine, comprising:
disposing a console on a top surface of a top cover of the washing machine;
inserting coupling ribs formed on a lower end of the decoration panel and/or on an inner rim of the decoration panel into coupling holes formed on the console; and
bending the coupling ribs inserted through the coupling holes so that the coupling ribs closely contact a rear surface of the console.

18. The method according to claim 17, further comprising pivoting the decoration panel after inserting the coupling ribs.

19. The method according to claim 17, further comprising depressing the decoration panel onto the front surface of the console before bending the coupling ribs.

20. The method according to claim 17, further comprising disposing a control panel on an inner portion of the decoration panel after bending the coupling ribs.
